(19) United States
(12) Patent Application Publication
(10) Pub. No.: US 2008/0083498 A1
(43) Pub. Date: Apr. 10, 2008

(54) METHOD OF MAKING A MOTOR VEHICLE PART

(75) Inventor: CHRISTIAN HANDING, Langenberg (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/867,937

(22) Filed: Oct. 5, 2007

(30) Foreign Application Priority Data
Oct. 6, 2006 (DE) 10 2006 047 805.3

(51) Int. Cl. C09J 5/02

(52) U.S. Cl. 156/322

(57) ABSTRACT

In a method of making a motor vehicle part, a metal sheet is hot formed to form a first structural component. Adhesive is applied upon a second structural component, and the first structural component, while still being warm, is joined with the second structural component by effecting an adhesive joint between the first and second structural components as a result of residual heat from the first structural component.

### CROSS-REFERENCES TO RELATED APPLICATIONS

This application claims the priority of German Patent Application, Serial No. 10 2006 047 805.3, filed Oct. 6, 2006, pursuant to 35 U.S.C. 119(a)-(d), the content of which is incorporated herein by reference in its entirety as if fully set forth herein.

### BACKGROUND OF THE INVENTION

The present invention relates to a method of making a motor vehicle part.

Nothing in the following discussion of the state of the art is to be construed as an admission of prior art.

German Offenlegungsschrift DE 103 39 350 A1 describes a shaping method in which a base blank and a reinforcement blank are fixed upon one another and jointly shaped. Subsequently, the base blank and the reinforcement blank are separated and joined back together with the assistance of an adhesive for carrying out a subsequent shaping process, whereby applied heat during the shaping process is used to melt the adhesive which hardens as it cools down.

German Offenlegungsschrift DE 103 52 513 A1 describes a compression-molding of a semifinished product in a hot-pressing tool to form a carrier part. Subsequently, at least one decorative element is laminated onto the carrier part, using residual heat of the carrier part.

It would be desirable and advantageous to provide an improved method of making a motor vehicle part to obviate prior art shortcomings.

### SUMMARY OF THE INVENTION

According to one aspect of the present invention, a method of making a motor vehicle part includes the steps of hot forming a metal sheet to form a first structural component, applying adhesive upon a second structural component, and joining the first structural component, while still being warm, with the second structural component, by effecting an adhesive joint between the first and second structural components as a result of residual heat from the first structural component.

The term “hot forming”, also called “hot forging”, as used in the disclosure relates to a working technology by which a metal material is heated and subjected to plastic working.

The adhesive may be applied on the second structural component in the form of an adhesive layer immediately prior to the joining step. Of course, it is also possible to deposit on the second structural component beforehand an adhesive store which is more or less solid and not sticky at room temperature. When contacting the warm first structural component, the adhesive melts to sufficiently wet the joining zone and to effect the joint, as the first structural component cools down.

The adhesive joint is realized subsequently to the hot forming process of the first structural component and exploiting the residual heat of the still warm first structural component. The second structural component, on the other hand, is cold or held at room temperature. Thus, the first and second structural components can be made separately from one another. This simplifies manufacture and logistics.

The term “motor vehicle part”, as used in the description relates to any body or structural part of a motor vehicle, such as A pillar, B pillar, or C pillar, door impact carrier, bumper beam, etc. The motor vehicle parts are made of at least two structural components which are joined together. At least one structural component is hereby made through hot forming in a press tool from a metal sheet that may, optionally, be pre-shaped. Connected by gluing to this hot formed first structural component is at least one further structural component. The second structural component may hereby involve a reinforcement or stiffening profile, hardware, or fittings, or the like. For example, a B pillar is typically provided with a reinforcement profile in the area of the lock.

According to another feature of the present invention, the first and second structural components may be made of different materials. Taking the afore-mentioned example of the B pillar, it is thus possible to make the B pillar, as first structural component, of steel sheet and to shape it in a hot forming process, while the second structural component is a reinforcement profile which is glued to the warm B pillar to complete the adhesive joint.

According to another feature of the present invention, the first structural component may be made of high-strength steel, and the second structural component may be an add-on part of light metal, such as aluminum for example. The second structural component may also be made of a fiber-reinforced plastic composite, e.g., carbon fiber reinforced plastic or glass fiber reinforced plastic. The combination of a first structural component of steel and a second structural component of fiber-reinforced plastic composite has many benefits as far as manufacturing is concerned.

According to another feature of the present invention, the first structural component and/or second structural components may also be made of coated metallic material. The coated metallic material may be made of zinc or aluminum. Thus, a first structural component of steel sheet with such a coated metallic material may be glued with a second structural component of aluminum, using the residual heat of the first structural component from the hot forming process.

The adhesive may be applied beforehand onto the second structural component. As soon as the first and second structural components come into contact with one another, heat of the first structural component causes the adhesive to react and to establish the adhesive joint.

In accordance with the present invention, residual heat of the first structural component after the hot forming process is thus exploited in a targeted manner to effect a hardening and fixation of the adhesive layer. As a result of the adhesive joint of both structural components, a handling strength can be adjusted. Suitably, a through hardening may be realized during a cathodic dip coating process for example, to which the joined first and second structural components can be jointly subjected subsequently.

A method of making a motor vehicle part in accordance with the present invention can be implemented economically and efficiently. There is no need for additional joining operations, such as, e.g., spot welding, penetration stacking, or punch riveting, or the like, thus saving costs.

The adhesive joint may also compensate a certain tolerance. Suitably, the adhesive may be a one-component adhesive or two-component adhesive on the basis of epoxy or polyurethane. An even force distribution is also realized in view of a large-area distribution of forces. Motor vehicle parts made in accordance with the present invention have a long service life, regardless whether they are subjected to static or dynamic loads, and exhibit a high stiffness. As the residual heat of the first structural component is utilized to melt the adhesive, there is no need for additional heat introduction in order to secure the second structural component, for example through soldering or welding. As a result, there is no change in texture or change in mechanical properties of the materials.

According to another feature of the present invention, the temperature of the first structural component may range between 50° C. and 350° C., preferably from 180° C. to 220° C. Of course, the second structural component may, optionally, also be heated up.

According to another feature of the present invention, the first structural component may be hardened at least partly in a shaping tool. Press hardening of the first structural component involves hot forming of the structural component and hardening thereof, while still being clamped in the press tool. As a result, the finished vehicle part is of high strength and true to size. Such hot formed and at least partly hardened structural components can then be joined with further structural components by gluing, using the residual heat which is present even after the hardening process.

In accordance with the present invention, the adhesive is applied onto the second structural component, regardless of the manufacturing process, and is of a type which is solid or partly solid at room temperature with no stickiness. The adhesive remains on the second structural component and defines a quasi adhesive store until the first structural component is joined thereto. Such an adhesive store may also be realized in the form of an adhesive strip. Examples of an adhesive may include epoxy adhesive, hot melt adhesive, or polyurethane adhesive.

When such an adhesive store is involved, the adhesion of the adhesive is established by the temperature increase as the first and second structural components are brought together. As the adhesive store melts, the viscosity is reduced. As a consequence of the reduced viscosity, a sufficient wetting of the joining zone is ensured. The cohesion and the joint between the first and second structural components are then realized by a cool down of the melt which tracks a cool down of the first structural component.

### BRIEF DESCRIPTION OF THE DRAWING

NONE

### DETAILED DESCRIPTION OF PREFERRED EMBODIMENTS

NONE

What is claimed as new and desired to be protected by Letters Patent is set forth in the appended claims and includes equivalents of the elements recited therein:

1. A method of making a motor vehicle part, comprising the steps of:
hot forming a metal sheet to form a first structural component;
applying adhesive upon a second structural component; and
joining the first structural component, while still being warm, with the second structural component, by effecting an adhesive joint between the first and second structural components as a result of residual heat from the first structural component.

2. The method of claim 1, wherein the adhesive is applied in the form of an adhesive layer immediately prior to the joining step.

3. The method of claim 1, further comprising the step of adjusting a temperature of the first structural component to a range between 50° C. and 350° C.

4. The method of claim 1, further comprising the step of adjusting a temperature of the first structural component to a range from 180° C. to 220° C.

5. The method of claim 1, wherein the first and second structural components are made of different materials.

6. The method of claim 5, wherein the first structural component is made of high strength steel, and the second structural component is made of light metal.

7. The method of claim 6, wherein the second structural component is made of aluminum.

8. The method of claim 5, wherein the first structural component is made of steel, and the second structural component is made of a fiber-reinforced plastic composite.

9. The method of claim 8, wherein the second structural component is made of carbon fiber reinforced plastic.

10. The method of claim 8, wherein the second structural component is made of glass fiber reinforced plastic.

11. The method of claim 1, wherein at least one of the first and second structural components is made of coated metallic material.

12. The method of claim 1, further comprising the step of hardening the first structural component, at least partly, in a shaping tool.

13. The method of claim 1, wherein the adhesive is epoxy adhesive.

14. The method of claim 1, wherein the adhesive is hot-melt adhesive.

15. The method of claim 1, wherein the adhesive is polyurethane adhesive.

16. The method of claim 1, further comprising the step of subjecting the joined first and second structural components together to a dip coating process.

17. The method of claim 16, further comprising the step of allowing the adhesive joint to undergo a through hardening during the dip coating process.
